(19) United States
(12) Patent Application Publication
(10) Pub. No.: US 2006/0036659 A1
(43) Pub. Date: Feb. 16, 2006

(54) Method of retrieving information using combined context based searching and content merging

(76) Inventors: Colin Capriati, Irvine, CA (US); John K. Sloatman, Studio City, CA (US)

Correspondence Address: BRUCE A. JAGGER, 6100 CENTER DRIVE, SUITE 630, LOS ANGELES, CA, 90045, US

(21) Appl. No.: 10/918,510

(22) Filed: Aug. 12, 2004

(51) Int. Cl. G06F 17/30

(52) U.S. Cl. 707/204

(57) ABSTRACT

The method combines searching based on the content of an original document with the merger of the original document and the results of the search. The operator of a client machine selects an original document, which contains several meaningful words, and loads it on the client machine. When the operator wishes to search on a network for related documents, the operator causes a content search application to parse the document for the meaningful words and to rank those words into a ranked list according to some predetermined order. The content search application then composes one or more search queries based on the terms in the ranked list. The application shows some form of the proposed query(ies) to the operator, and accepts the operator's input, which input may be in the form of additions, rejections, or accepting the terms and/or phrasing of the query. The application submits at least one operator approved query to at least one search engine on a network, and accepts the list of hits returned by that search engine. The application ranks the hits by their relevance to the original query, and returns the ranked list of hits to the client machine. There the application displays the first hit together with the original document for the operator's consideration of the two in the context of one another.

### BACKGROUND OF THE INVENTION

1. Field of the Invention

The invention relates in general to methods of client side information aggregation from a plurality of sources based on a search query that is the result of a combination of operator input and the parsing of a first content by an application, coupled with a composite display at the client of information from different sources.

2. Description of the Prior Art

The prior art searching and information aggregation methods are not without their shortcomings. Numerous expedients had been proposed for searching through large masses of randomly distributed information on networks such as the internet. Many search sites, such as the search engine, Google.com, send out programs that are know as spiders to roam through networks, such as the internet, collecting data with which to locate specific information at some later time in response to a specific query from a user. Typically, large search sites maintain the data they collect in some form of database. They do not keep verbatim copies of the web sites they collect data on. In response to a query from a user search engines typically search the databases they have compiled rather than the original content. Typically, the original content is available only from the site where it is located. The effectiveness of a search query in finding relevant information depends in part on the quality of the database that the query is submitted to, and in part on the quality of the search query. Some search engines primarily search only their own databases, while others rely in part or entirely on the databases of other search engines. Spreading a search query among several databases tends to negate some of the problems that are inherent in the choices each search site makes in collecting data. Some search engines submit the queries they receive to several different search engines, and collect and rank the results into one list of results.

Typically, search engines will return results to a query in the form of a list of abstracts or other unique identifiers that symbolize the located content. The content can be in the form of text or still image based documents, sounds, animated images, moving images, combinations thereof, or the like. The unique identifiers can be of similar form to the content they symbolize.

Searching of a network for information typically proceeds on the basis of a search query that is composed by a searcher and submitted to a search engine for execution. Many researchers are not particularly adept at composing effective search queries, so relevant content is either overlooked or is buried in too many irrelevant hits. This limits the usefulness of the information that is available. Various proposals had been made to facilitate finding related information. For example, many search engines list “Similar pages” or some such listing with every hit. These are generally not closely targeted enough to the desired information to be very helpful. They are often based primarily on the hit, which is drawn from a database rather than the original source.

A searcher will occasionally have in hand some document or other content that addresses the specific information that is of interest, and wishes to find other closely similar or otherwise related content. It is sometimes possible with the expenditure of some considerable time and effort, to pull from the reference in hand the information that is necessary to phrase a specific search query to look for the desired additional information. This requires close attention to detail, is error prone, and consumes more time than may be available for completing the search. Simply parsing a specific content by hand or electronically often overlooks certain details that are critical to composing an effective search query. The specific reference, for example, may simply suggest without describing a particular detail that is of great significance. Simply parsing the reference does not focus the query on the exact area of interest, because the reference does not contain the exact term or terms that are needed to focus the search. Search queries, when properly phrased with the right terms, often limit the search results to the most relevant results or hits. Many searchers are unwilling or unable to spend the time to properly phrase search requests or to identify the most relevant search terms. Therefore, the value of information that is available but undiscovered goes unrealized. Improvement is needed.

Bits and pieces of information often take on added meaning when they are compared with other bits and pieces of information, which may, at first blush, appear to be unrelated. Previously proposed expedients for presenting information from search queries often was unsatisfactory.

These and other difficulties of the prior art have been overcome according to the present invention.

### BRIEF SUMMARY OF THE INVENTION

The present invention has been developed in response to the current state of the art, and in particular, in response to these and other problems and needs that have not been fully or completely solved by currently available search and presentation methods. Thus, it is an overall object of the present invention to effectively resolve at least the problems and shortcomings identified herein. In particular, it is an object of the present invention to provide an effective search and information presentation method. Embodiments of the present invention are particularly suitable for use in searching the internet and other networks where huge quantities of randomly distributed information need to be searched efficiently for specific information.

In a preferred embodiment according to the present invention, an operator of a client machine loads a first document or other first content onto the client machine and the client displays it on the client's monitor. The first document or other first content may be located by a search engine or other search site based on an operator specified search query, or it may be located by the operator in some other way. In any event, the operator of a client machine selects the first content.

A search aid application then draws information from at least one and preferably two different sources and composes an application derived search query. To accomplish this, the search aid application parses the operator selected first content for meaningful terms and selects at least one, and preferably at least two, of those meaningful terms for inclusion in the application derived search query that it is composing. Preferably, the search aid application identifies the meaningful terms in the first document or other first content and determines the frequency of occurrence of those meaningful terms in the first content. It then selects those meaningful terms that have the highest frequency of occurrence. Other systems of identifying and ranking the meaningful terms can be employed, if desired.

The operator contributes part of the application derived search query. The search aid application takes the operator's input and includes it in the search query. That input may be, for example, in the form of the original search query that the operator used to find the first content, some other term that the operator otherwise provides, or the operator declining the opportunity to furnish a part of the search query, or the like. Preferably, the part of the query that is derived from parsing the first content is displayed to the operator so that it may be taken into consideration as the operator decides on what input to contribute to the application derived search query.

The search aid application submits the application derived search query to an associated search engine application. The search engine application is preferably located on a searching server machine that is remote from the client machine. The searching server machine typically is configured to accommodate the submission of application generated search queries from many different client machines substantially simultaneously. The associated search engine application submits this application derived search query, either sequentially or simultaneously, to at least one, and preferably to several different search engines or other search sites. The search sites execute the search query and report back to the associated search engine application the hits they find. Each hit is uniquely identified, and usually, but not necessarily, each hit is uniquely described or symbolized by an abstract. This search engine application compiles the abstracts or other unique identifiers into one or more lists with the identifiers preferably, but not necessarily, ranked based on their relevance to the application derived search query. The search engine application then reports at least one, and usually several, of the top ranked unique identifiers to the search aid application.

The search aid application causes the client to display to the operator a first identifier, usually the top ranked abstract or other unique identifier. The manner of display is such that both the first content and the first identifier are immediately, if not simultaneously, available to the operator.

The operator can cause a second or subsequent identifier to be displayed on the client monitor sequentially or simultaneously with the first identifier. The operator can cause the second or subsequent content, which is symbolized by a first or subsequent displayed identifier, be retrieved in full and similarly displayed in place of or along with the first abstract or other first identifier.

The operator has control over the selection of the first content and over the composition of part of the machine derived search query. The operator also has control over the final winnowing of the application ranked search generated abstracts or other unique identifiers, and the selection and retrieval of full second or subsequent content. Subsequent to the initial application controlled display of the first content and the first unique identifier or the content it symbolizes, the operator can exercise control over which identifiers and contents are displayed and whether they are displayed simultaneously or not. Alternatively, the machine will select and display content or identifiers sequentially if authorized to do so by the operator.

The search aid application composes the application derived search query, submits it to the associated search engine application, accepts the resulting search results, and displays them for the operator in immediate association with the operator selected first content.

The associated search engine application accepts the machine derived search query from the search aid application, submits it to one or more search engines or other search sites, compiles the resulting list of abstracts into preferably one report, ranks the abstracts as to relevance to the application derived search query, and submits the ranked list to the search aid application.

Several alternatives are preferably available to the operator in selecting the part of the part of the application derived search query that the operator has the opportunity to provide. For example, if desired, the operator can be afforded the option to highlight and right click on a term in the first document or other content, type in a term in a pop-up box or the browser address bar, or elect not to select any term for inclusion in the application derived search query. In the event the operator elects not to select such a term, the search aid application will compose an application derived search query from just its parsing of the first content alone. That is, if the operator's input to the application derived search query is to forego the opportunity to contribute a term, that is still a selection or contribution of input by the operator. The search query will reflect the operator's choices. Operator input includes both terms that are entered and the choice not to enter any terms.

According to one preferred embodiment, the operator of a client machine selects a document, which contains several meaningful words. The operator causes a content search application to parse the document for the meaningful words, and to rank those words into a ranked list according to some predetermined order. The content search application then composes a search query based on the terms in the ranked list. The application shows the proposed query to the operator, and accepts the operator's input, which input may be in the form of additions, delections, or accepting the terms or phrasing of the query. The application submits the operator approved query to at least one search engine on a network, and accepts the list of hits returned by that search engine. The application ranks the hits by their relevance to the original query, and returns the ranked list of hits to the client machine. There the application displays the first hit together with the original document for the operator's consideration of the two in context with one another.

To acquaint persons skilled in the pertinent arts most closely related to the present invention, a preferred embodiment of a method that illustrates a best mode now contemplated for putting the invention into practice is described herein by, and with reference to, the annexed drawings that form a part of the specification. The exemplary method is described in detail without attempting to show all of the various forms and modifications in which the invention might be embodied. As such, the embodiments shown and described herein are illustrative, and as will become apparent to those skilled in the arts, can be modified in numerous ways within the scope and spirit of the invention, the invention being measured by the appended claims and not by the details of the specification or drawings.

Other objects, advantages, and novel features of the present invention will become more fully apparent from the following detailed description of the invention when considered in conjunction with the accompanying drawings, or may be learned by the practice of the invention as set forth herein.

### BRIEF DESCRIPTION OF THE DRAWINGS

The present invention provides its benefits across a broad spectrum of search and information presentation methods. While the description which follows hereinafter is meant to be representative of a number of such applications, it is not exhaustive. As those skilled in the art will recognize, the basic apparatus taught herein can be readily adapted to many uses. This specification and the claims appended hereto should be accorded a breadth in keeping with the scope and spirit of the invention being disclosed despite what might appear to be limiting language imposed by the requirements of referring to the specific examples disclosed.

Referring particularly to the drawings for the purposes of illustrating the invention and its presently understood best mode only and not limitation:

FIG. 1 is a diagrammatic representation of the steps in a preferred embodiment of the invention.

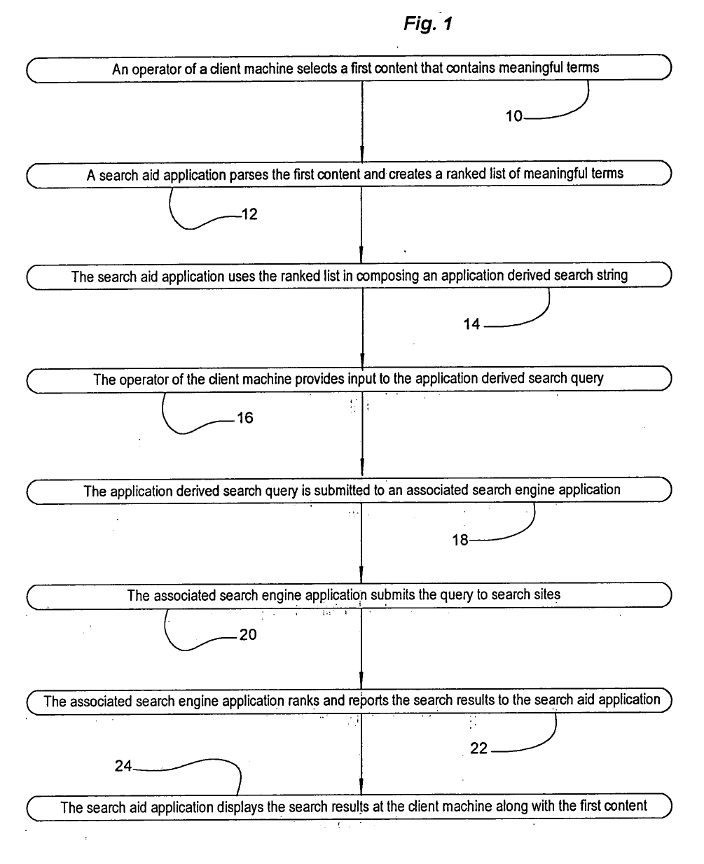

### DETAILED DESCRIPTION OF THE PREFERRED EMBODIMENTS

Referring now to the drawings, it is to be understood that the drawings are diagrammatic and schematic representations of an embodiment of the invention, and are not to be construed as limiting the invention in any way. The use of words and phrases herein with reference to specific embodiments is not intended to limit the meanings of such words and phrases to those specific embodiments. Words and phrases herein are intended to have their ordinary meanings, unless a specific definition is set forth at length herein.

Referring particularly to the drawings, there is illustrated generally at 10 a step wherein an operator of a client machine selects an electronic file (first content), which file contains information that is relevant to a particular subject about which the operator wishes to find additional information. The first content can be located on the client machine or somewhere else on a network where it is accessible to the operator. It may be something that the operator generated. The first content may be distributed throughout several electronic files so long as they are all available to the search aid application for parsing in step 12. The operator causes the first content to be displayed at the client machine where it is available to the operator. The first content includes meaningful terms that pertain to the subject of interest, but it need not contain all of or even the most significant meaningful terms as applied to the subject under consideration. The meaningful terms can be textual, graphics, mathematical or chemical symbols, images, sounds, combinations thereof, or the like, so long as they are can be composed into a search query. As a first approximation, it is assumed that the most meaningful terms are the ones that are used most often in the first content. Based on this assumption, the operator then causes a search engine application to parse the first content. Typically, but not necessarily, the search aid application is located on the client machine under the operator's direct control. Having this application on the client machine generally facilitates the necessary interaction between the operator and the search aid application.

In step 12 the search aid application identifies the meaningful terms in the first content and ranks them by frequency of occurrence with the most frequently occurring meaningful terms at the top of the ranking. If desired, the resulting ranked list can be weighted by reference to some other data, for example, a glossary that limits the choice of meaningful terms. This application, for example, may only be permitted to pick, or must assign particular weight to terms that appear in both the glossary and the first content. Also, some terms may be afforded more weight than others, and the like. The output of step 12 is a ranked list of meaningful terms. Typically, the number of terms on the ranked list is arbitrarily limited to a certain number of terms, for example, 5 or 10. When the parsing and ranking are complete, it may be that there is only one meaningful term on the ranked list. This ranked list will serve as the basis for an application derived search query.

Typically, but not necessarily, the search aid application causes the ranked list generated in step 12 to be displayed to the operator of the client machine for consideration before proceeding further. The operator provides input to the formulation of the query. The operator has the opportunity to accept or reject any one or more of the terms on the ranked list. Importantly, the operator, in step 16 also has the opportunity to add or decline to add terms to the search query that is in the process of being composed. The composing of the application derived search query is a collaborative effort between this application and the operator. The application does the time consuming job of accurately parsing the first content and ranking meaningful terms, while the operator contributes judgment and other terms that are known to the operator to be particularly meaningful to the subject at hand. The search aid application composes a search query. Preferably, but not necessarily, the search aid application at the end of step 16 presents the operator with a completed proposed application derived search query. The operator is then afforded the opportunity to review and modify the terms or phrasing of the query. Where the operator has limited experience in phrasing searches, the afforded opportunity may, if desired, exclude modification of the phrasing.

When the operator has finished reviewing and modifying the query, it is submitted in step 18 to an associated search engine application. The associated search engine application generally checks the query for searchable phrasing. If the phrasing is not searchable, this application rejects the query.

In step 20, the associated search engine application submits the application derived search query to at least one, and preferably, to several search sites. This application may submit the query to a search site it is associated with and/or to search sites with which it has no association. Typically, the search sites have databases of information and searching protocols that they apply to searching any query that is submitted to them. These databases and searching protocols differ greatly from one search site to another. It is therefore desirable to submit the search query to several separate search sites of different kinds and descriptions. The associated search engine application receives the search results (hits) from the various search sites, compiles the results, preferably into one list, ranks the results, preferably based on relevance to the query. The search results or hits are typically in the form of textual abstracts, thumbnails of symbols, graphics, or images, combinations thereof, or other unique identifiers. Each unique identifier describes the content that it symbolizes with sufficient detail to enable the operator to preliminarily evaluate the relevance of the content. Where the content is textual in nature, the unique identifier may be in the form of a textual abstract. Where the content is graphic or in the form of a symbol or an image, the unique identifier may be a thumbnail graphic, symbol, or image with or without associated text.

The ranked list of search results from step 20 are reported back to the search aid application by the associated search engine application in step 22. In step 24 the search aid application takes the ranked list of search results returned by the associated search engine application and causes them to be displayed in a meaningful way for the operator. Typically, but not necessarily, the ranked list of results is in the form of a list of unique identifiers. The search aid application typically, but not necessarily, takes the top ranked (first) unique identifier and displays it at the client machine along with the first content. If desired, and at the discretion of the operator, the second content, which is symbolized by the first unique operator is displayed instead of the first unique identifier. The display preferably places both the first unique identifier and the first content on the screen simultaneously so that both can be viewed at the same time. If the operator desires, and at the operator's control, the display of the first unique identifier or the second content can be in a window that overlays, under lays or is tiled with a window containing the first content so that both are immediately available by toggling between them. The immediate availability of the first content and one or more unique identifiers or second contents in context with one another allows the operator to quickly understand and evaluate the second content. The search aid application presents the first content and the top item on the ranked list of hits to the operator. Control over the selection and display of subsequent unique identifiers or contents rests with the operator.

Typically, the networks to which the present invention is particularly applicable are large such as the internet, particularly the world wide web, wide area networks, and local area networks. Such networks have a huge amount of information in electronic form generally randomly distributed around them in various locations. The various machines in a network are interconnected, for example, by conductive wires, fiber optic cables, or wirelessly by radio, infrared or the like emissions, or combinations thereof. The architecture of the network can be any of the conventional forms, including random, peer to peer, ring, combinations thereof, or the like.

Client machines are typically some form of computer (stand alone, portable, smart terminal, dumb terminal, or the like) that is capable by reason of the assembled hardware and software of interconnecting with a network. When so interconnected the client is a part of the network, and any content on the client machine is to be considered a part of the network. Client machines can be connected in a variety of ways to networks. They can, for example, remain connected at all times or they can be connected only when desired by the operator of the client machine. Such connections can be wired or wireless.

Large networks such as the internet typically include many different open content databases. That is, the contents in the databases are open to the public, and can be accessed, for example, by the operator of a client machine at some other location on the network. The contents in some databases are closed to the public and can be accessed only through passwords or other security procedures.

Content from a network, or a unique identifier that symbolizes a particular unique content can be displayed at a client machine by causing the content or its identifier to appear on a monitor. Other forms of display are possible, including, for example, audible emissions, visual projections of information to or by devices other than monitors, printers, combinations thereof, or the like. The information contained in a network is typically contained in discrete units or contents on various machines distributed around the network. The contents are typically in machine readable electronic files, the formats of which permit them to be perceived as text, graphics, symbols, images, moving images, sounds, combinations thereof, or the like.

A particular single unique content can be very large or very small, and it may be stored in more than one electronic file. Regardless of the size, each unique content typically includes a number of meaningful terms. Searchable meaningful terms include, for example, words, symbols from mathematics, chemistry, CAD drawings, physics, graphic symbols, sounds, combinations thereof, and the like. By common convention, meaningful words typically exclude articles of speech and the 300 most common words in the English language. Most other languages have comparable “noise” words that are not considered to be meaningful terms for purposes of searching. If desired, for purposes of practicing the present invention, a special glossary of meaningful terms that are specific to a particular art or activity can be prepared or selected, with the search application being limited to building queries from terms that appear in that special glossary and the content that is parsed. That is, the terms in the search query should appear in both the parsed content and the special glossary.

A content search application according to the present invention can be located entirely on one site, but is typically bifurcated between a client machine and a server machine that is remotely located from the client machine. A server machine is typically adapted to processing the search requests of a number of different clients on a simultaneous or nearly simultaneous basis. The search engine application software and hardware required for processing search queries can be located at one server machine much more efficiently and economically than providing them at each client machine. Preferably, a search aid application is located at the client machine to formulate a search query, and present the results of the resulting search to the operator in a helpful way. An associated search engine application is provided at the server machine to execute the search query, and rank, and return the results. Other distributions and arrangements of the software and hardware are possible, if desired.

Allowing the search aid application to compose the search query substantially improves the quality of the search results. This affords the opportunity to provide the software with the capability of composing very sophisticated search algorithms using the ranked meaningful terms. Different search engines respond optimally to different search algorithms. The same search engine may also respond very differently to two different search queries that include the same meaningful terms but are phrased differently. The composing of complicated search algorithms is beyond the capabilities of many casual search engine users, particularly in specialized fields such as chemistry or mathematics. As new features are added to search engines, many users do not keep up on the latest details of composing search queries to take advantage of the new features. Software can be continually updated to take advantage of the latest features. If desired, the search aid application can be programmed to compose a separate search algorithm that is optimal for each search engine. The search aid application then indicates to the associated search application which algorithm is to be submitted to a particular search engine. Also, more than one search algorithm can be composed and submitted to the same search engine. Depending on the desires of the operator, the search aid application may display to the operator the full search algorithm or just the terms that are used in the search algorithm.

As will be understood by those skilled in the art, the present invention greatly enhances the efficiency, usability, and accuracy of searching activities, particularly across large networks. For example, an electronic copy of an article about the Widget Company can be selected or created by an operator and loaded on a client machine. A content search application according to the present invention is activated by the operator and instructed by the operator to make a context based search for content related to the Widget Company.

The content search application parses the electronic copy of the article that is loaded on the client machine and prepares a list of the most frequently occurring words ranked, for example, by frequency of occurrence. The application also prepares and presents the operator with at least one proposed search algorithm or query based on this ranked list of words.

Upon review of the proposed search algorithm(s) and the article, the operator finds that the company name is mentioned 5 times (four times as “Widget Company” and once as “Widget”), the President's name 3 times (once as “Widget”, and twice as “William Widget”), the Company's products twice (once as “Super Widget” and once as “Widget”), and the industry sector once (as “electronic exercise widgets”). The content search application is unable to distinguish between “Widget” as a company name, a person's name, a product name, or an industry sector name. The operator must provide some input to the search algorithm (typically at least in the form of phrasing) to sort out to which meaning the application derived search query(ies) is to be directed.

There is no mention of stock, or stock price, or financial information of any kind in the article that the application parsed. Thus, there are no terms related to this type of information in the ranked list. If, for example, the operator wants to check the history of the price of the Widget Company stock, the operator must add one or more terms to the proposed search algorithm to focus the search in that direction. The terms can be added, for example, to the list of ranked words, or directly to the query itself if the operator is skilled enough to phrase a proper search algorithm. Such terms, for example, might include the word “stock” or the phrase “chart of stock price”. As used in the present specification and claims, “term” includes words, symbols, phrases, and all other searchable elements that can be included in a search algorithm. At the operator's option several different application derived search algorithms can be composed.

The content search application executes (typically through a part of the software located on a remote server) the application derived search algorithm(s), preferably on several different search engines. As used herein, “search engine” is inclusive of all of the various search facilitating sites that are available on a network. As previously described, such search facilitating sites typically include some form of proprietary database that permits them to compare a search algorithm to the contents of that database rather than directly to the source of the information. Customized search algorithms can be submitted to separate search engines, or the same algorithm can be submitted to a number of different search engines. The search engines return lists of results or hits, and the content search application compiles the hits, preferably into one list, ranked according to its relevance to the search query. Where several queries are used it may be necessary to select a master query to use as the standard for ranking purposes, or several lists may be submitted to the client machine.

The ranked search results obtained from the context based searching are then subjected to a content merging step at the client machine. The results can, for example, be displayed at the client machine in the form of one or more unique identifiers or contents along with the original article. If, for example, the two top unique identifiers are the legends from two different charts of stock price movements (the first unique identifier is “Chart of Widget Company Stock Price Movement 1999-2004”, and the second unique identifier is “Chart of Composite Stock Price Movement In Electronic Widget Industry”), the operator could pick the one that is most relevant to the operator's concerns, and cause the chart itself to be displayed along with the original article. If desired, the application can be instructed to automatically display content rather than unique identifiers. The operator can then study the two, print them as one document, copy them as one document to a report, forward them as one document to others, or the like. Both charts can be similarly presented simultaneously with one another and/or the original article, if desired by the operator. The combined context based search and content merge greatly extends the usefulness, usability, and accuracy of the search method.

Many modifications and variations of the present invention are possible in light of the above teachings. It is therefore to be understood that, within the scope of the appended claims, the invention may be practiced otherwise than as specifically described.

What is claimed is:

1. A method of selecting, searching for, and aggregating content at a client machine, said method comprising:
allowing an operator of said client machine to select a first content;
activating a search aid application, and permitting said search aid application to parse said first content for meaningful terms, to select at least one said meaningful search term, to accept input from said operator, to compose at least one application derived search query from said at least one meaningful search term and said input, and to submit said application derived search query to an associated search engine application;
allowing said associated search engine application to submit said application derived search query to at least one search site, to receive back from said at least one search site a plurality of a unique identifiers, to arrange said unique identifiers into a ranked list by their relevance to said application derived search query, and to report said ranked list to said search aid application;
allowing said search aid application to select a first said unique identifier from said ranked list and to cause said first unique identifier or a second content that it symbolizes to be displayed at said client and to be immediately available to said operator together with said first content.

2. A method of claim 1 wherein said search aid application is located on said client machine.

3. A method of claim 1 wherein said input comprises allowing said operator to review and change terms included within and phrasing of said application derived search query.

4. A method of claim 1 wherein said search aid application is located on said client machine, and said search engine application is located on a machine that is remote from said client machine.

5. A method of claim 1 including causing said first unique identifier or said first content that it symbolizes to be displayed at said client simultaneously with said first content.

6. A method of claim 1 wherein said input comprises at least allowing said operator to review said application derived search query and reject or accept such query.

7. A method of claim 1 including allowing said operator to cause a second content that is symbolized by said first unique identifier to be displayed and immediately available with said first content.

8. A method of claim 1 including after allowing said search aid application to cause said first unique identifier or said content symbolized by said first unique identifier to be displayed at said client, allowing said operator to control the selection and display of any said unique identifier or content symbolized by said any unique identifier.

9. A method of selecting, search for, and aggregating content from a network at a client machine, which network has a plurality of open content databases associated therewith, said method comprising:
selecting a said network and connecting said client machine to said network;
allowing an operator of said client machine to select a first content, to cause at least a portion of said first content to be displayed at said client machine, said first content including a plurality of meaningful terms, and to activate a content search application, said content search application being at least partially located on said client;
permitting said content search application to determine at least the most meaningful terms in said first content, to prepare at least a search algorithm based on at least said most meaningful terms and input from said operator, to allow said content search application to at least indirectly query several of said plurality of open content databases using said search algorithm, and to select at least a second content that results from said query; and
allowing said content search application to display at least an abstract of said second content at said client with said first content being immediately available to said operator.

10. A method of claim 9 including permitting said content search application to determine several of the most frequently occurring meaningful terms in said first content, and ranking said terms in said ranked list at least partially on the frequency of the occurrence of said meaningful terms.

11. A method of claim 9 wherein said network is the internet.

12. A method of claim 9 wherein a portion of said content search application is located on a server machine that is remote from said client machine and allowing said portion of said content search engine on said server machine to directly query said several open content databases.

13. A method of claim 9 including allowing said content search application to select at least two of said second contents from said network, and allowing said operator to sequentially or simultaneously display at least abstracts of said two of said second contents with said first content

14. A method of claim 9 wherein said network is the world wide web, a wide area network or a local area network

15. A method of claim 9 wherein said permitting includes enabling said content search application to apply several different criteria in using said meaningful terms in preparing said search algorithm.

16. A method of claim 9 including permitting said content search application to determine at least the most frequently occurring said meaningful term in said first and second contents combined, and allowing said content search application to select at least a third content based on said at least the most frequently occurring said meaningful term in said first and second contents combined.

17. A method of claim 9 wherein said input from said operator includes allowing said operator to determine how many terms from such ranked list to use in selecting said second content.

18. A method of claim 9 wherein said input from said operator includes allowing said operator to determine which terms from said ranked list to use in selecting said second content.

19. A method of claim 9 including enabling said operator to control the display of said second contents after said first at least an abstract of said second content is displayed with said first content.

20. A method of searching and presenting retrieved information including combining context based searching and content merging, said method comprising:
composing a context based search algorithm including allowing an operator to load original content in electronic form on a client machine, activating a search aid application and allowing said search aid application to parse said original content for meaningful terms, to compose at least one proposed context based search algorithm based on said meaningful terms, to accept input to said context based search algorithm from an operator of said client machine, and to submit at least one said context based search algorithm to an associated search engine application;
allowing said associated search engine application to submit at least one said context based search algorithm to at least one search site, to receive back from said at least one search site a plurality of a unique identifiers, to arrange said unique identifiers into a list, and to report said list to said search aid application;
allowing said search aid application to select a first said unique identifier from said list and to cause said first unique identifier or a second content that it symbolizes to be merged with said original content and displayed at said client.

21. A method of selecting, searching for, and aggregating content at a client machine that is connected to a network comprising:
allowing an operator of said client machine to select a first content;
enabling a content search application to compose a search query by preparing a list of meaningful terms that occur in said first content, ranking said list of meaningful terms to generate a ranked list, accepting input from said operator concerning the composing of said search query, and composing at least one search query based on said operator input and said ranked list; and
permitting said content search application to execute said search query on several search engines distributed around a network to generate a plurality of hits including at least a hit from each of at least two of said search engines, to select a said hit from said plurality of hits, and to display at least said selected hit at said client machine so it is immediately available to said operator with said first content.

22. A method of claim 21 including permitting said content search application to execute said search query through a server machine located elsewhere on said network.

23. A method of claim 21 wherein said content search application is located partly on said client machine and partly on a server machine located elsewhere on said network.

24. A method of claim 21 including permitting said content search application to display at least said selected hit at said client machine simultaneously with said first content.

25. A method of claim 21 wherein said accepting input includes enabling said operator to add, accept, or reject terms and phrasing of said search query.

26. A method of claim 21 including enabling said search content application to compose at least two said search queries.

27. A method of claim 21 including enabling said search content application to compose at least first and second said search queries, and permitting said content search application to execute said first search query on a first said search engine and to execute said second search query on a second said search engine.

28. A method of selecting, search for, and aggregating content from a network at a client machine, which network has a plurality of open content databases associated therewith, said method comprising:
selecting a said network and connecting said client machine to said network;
allowing an operator of said client machine to select a first content from anywhere on said network, to cause at least a portion of said first content to be displayed at said client machine, said first content including a plurality of meaningful terms, and to activate a content search application, said content search application being at least partially located on said client and being adapted to accessing a server machine on said network;
permitting said content search application to parse said first content for meaningful terms, to establish a term list of said meaningful term, to allow said content search application to compose at least first and second search algorithms based on said term list and on input from said operator, to at least indirectly submit said first algorithm to a first said open content database and said second algorithm to a second said open content database, and to select at least a second content from said network; and
allowing said content search application to display at least an abstract of said second content at said client with said first content being immediately available to said operator.
